(19) United States
(12) Patent Application Publication
(10) Pub. No.: US 2016/0266827 A1
(43) Pub. Date: Sep. 15, 2016

(54) MEMORY CONTROLLER, MEMORY DEVICE, DATA TRANSFER SYSTEM, DATA TRANSFER METHOD, AND COMPUTER PROGRAM PRODUCT

(71) Applicant: Kabushiki Kaisha Toshiba, Minato-ku (JP)

(72) Inventors: Yohei HASEGAWA, Kawasaki (JP); Yoshiki SAITO, Yokohama (JP); Shigehiro ASANO, Yokosuka (JP)

(73) Assignee: Kabushiki Kaisha Toshiba, Minato-ku (JP)

(21) Appl. No.: 14/922,577

(22) Filed: Oct. 26, 2015

(30) Foreign Application Priority Data
Mar. 13, 2015 (JP) 2015-050896

(51) Int. Cl. G06F 3/06; G06F 12/08

(52) U.S. Cl. CPC G06F 3/0619; G06F 3/0647; G06F 3/0685; G06F 12/0802; G06F 2212/1032; G06F 2212/205

(57) ABSTRACT

A memory controller that controls data transfer performed between a memory device and another memory device, the memory controller includes: an acquiring unit that acquires command information which contains first address information indicating a first memory area to be accessed during the data transfer; a determining unit that determines whether the first memory area belongs to a specific external address space which represents a specific address space in an external memory; and a converting unit that, when the first memory area belongs to the specific external address space, converts, based on conversion information indicating correspondence relationship between the specific external address space and a specific internal address space which represents a specific address space in the first memory device, the first address information into second address information indicating a second memory area belonging to the specific internal address space.

### CROSS-REFERENCE TO RELATED APPLICATION

This application is based upon and claims the benefit of priority from Japanese Patent Application No. 2015-050896, filed on Mar. 13, 2015; the entire contents of which are incorporated herein by reference.

### FIELD

Embodiments described herein relate generally to a memory controller, a memory device, a data transfer system, a data transfer method, and a computer program product.

### BACKGROUND

In solid state drives (SSDs) that are achieving higher and higher speeds, it is becoming common practice to use the PCIe interface (PCIe stands for Peripheral Components Interconnect Express) as the bus interface. The PCIe interface represents an interface for connecting an expansion device such as a graphic card to a computer such as a personal computer (PC) or a server, and is capable of assigning a memory area in the expansion device as a specific area of the address space in the system memory. As a result of implementing this function, the host processor becomes able to use the memory addresses indicating the memory areas to be accessed, and to perform reading and writing with respect to the memory areas in the expansion device.

A memory device is available which includes a nonvolatile memory and a random access memory (RAM) that is accessible using memory addresses by the host processor. In the memory device, when the power is shutdown, the data stored in the RAM is moved to the nonvolatile memory. When the power is restored, the data that was moved is read from the nonvolatile memory and the state of the RAM is restored.

Moreover, a memory device is available which includes a nonvolatile memory and a RAM that is accessible using memory addresses by the host processor, and in which the memory positions in the nonvolatile memory corresponding to the memory addresses are managed in a table.

In the case of taking backup of a memory device or creating a snapshot of a memory device, it is necessary to perform data transfer among memory devices. In a commonly-used computer architecture, memory devices such as a solid state drive (SSD) and a hard disk drive (HDD) are used as secondary memory areas of the main memory area of the host computer. Thus, the main memory area of the host computer represents an external memory for such memory devices. For that reason, an interface for memory devices, such as the SATA interface (SATA stands for Serial Advanced Technology Attachment) or the NVMe interface (NVMe stands for Non-Volatile Memory Express), is designed under the premise that data transfer is performed between the main memory area and the memory area in a memory device. Hence, during the data transfer among memory devices, it becomes necessary to perform data transfer via the main memory area (the external memory) other than the memory devices.

### BRIEF DESCRIPTION OF THE DRAWINGS

FIG. 1 is a diagram illustrating a configuration of a data transfer system according to a first embodiment;

FIG. 2 is a diagram illustrating command information;

FIG. 3 is a diagram illustrating address information that includes information indicating the data size;

FIG. 4 is a diagram illustrating external address space information;

FIG. 5 is a diagram that schematically illustrates an operation for converting a memory area (a first-type memory area) belonging to a specific external address space into a memory area (a second-type memory area) belonging to a specific internal address space;

FIG. 6 is a diagram illustrating a hardware configuration of the data transfer system according to the first embodiment;

FIG. 7 is a flowchart for explaining a sequence of operations performed in a first memory device;

FIG. 8 is a flowchart for explaining a sequence of operations during a reading operation performed in the data transfer system according to the first embodiment;

FIG. 9 is a flowchart for explaining a sequence of operations during a writing operation performed in the data transfer system according to the first embodiment;

FIG. 10 is a diagram illustrating a configuration of a data transfer system according to a second embodiment;

FIG. 11 is a flowchart for explaining a sequence of operations during a reading operation performed in the data transfer system according to the second embodiment;

FIG. 12 is a flowchart for explaining a sequence of operations during a writing operation performed in the data transfer system according to the second embodiment;

FIG. 13 is a diagram illustrating a configuration of a data transfer system according to a third embodiment;

FIG. 14 is a flowchart for explaining a sequence of operations during a reading and writing operation performed in the data transfer system according to the third embodiment;

FIG. 15 is a diagram illustrating a configuration of a data transfer system according to a fourth embodiment; and

FIG. 16 is a flowchart for explaining a sequence of operations during a reading and writing operation performed in the data transfer system according to the fourth embodiment.

### DETAILED DESCRIPTION

### First Embodiment

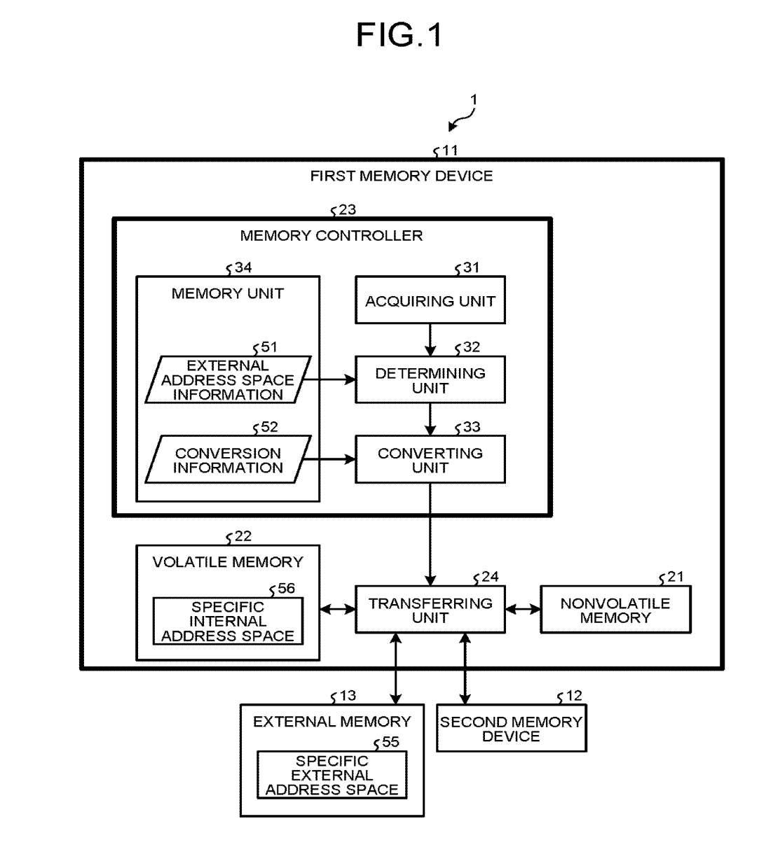

FIG. 1 is a diagram illustrating an exemplary configuration of a data transfer system 1 according to a first embodiment. The data transfer system 1 includes a first memory device 11 (a memory device), a second memory device 12 (another memory device), and an external memory 13.

The data transfer is performed between the first memory device 11 and the second memory device 12. Herein, the first memory device 11 and the second memory device 12 are assumed to be solid state drives (SSDs). However, that is not the only possible case. The external memory 13 is assumed to be the main memory area, which includes a random access memory (RAM), of a host computer. However, that is not the only possible case. In the first embodiment, the data transfer is sometimes performed via the external memory 13, and sometimes performed directly between the first memory device 11 and the second memory device 12.

The first memory device 11 includes a nonvolatile memory 21, a volatile memory 22, a memory controller 23, and a transferring unit 24.

The nonvolatile memory 21 functions as the principal memory medium of the first memory device 11, and is used to store the target data for data transfer. Herein, the nonvolatile memory 21 is assumed to be a NAND flash memory used in a commonly-used SSD. However, that is not the only possible case. Moreover, although the nonvolatile memory 21 is assumed to be nonvolatile in nature, it is also possible to have a configuration in which a volatile memory such as a dynamic random access memory (DRAM) is used along with a data protecting unit that moves the data to a predetermined memory in the case of power shutdown. The nonvolatile memory 21 is configured with one or more modules. When a plurality of modules is made to perform operations in parallel, it becomes possible to achieve high-speed processing.

The volatile memory 22 includes memory areas that are accessible using memory addresses by an external device such as the host computer or the second memory device 12. Herein, the volatile memory 22 is assumed to be a dynamic random access memory (DRAM) or a static random access memory (SRAM). However, that is not the only possible case. In FIG. 1 is illustrated a configuration in which the volatile memory 22 is installed on the outside of the memory controller 23 (described later). Alternatively, the volatile memory 22 can be installed inside the memory controller 23. Although the volatile memory 22 is assumed to be volatile in nature, it is alternatively possible to use a nonvolatile memory such as a magnetoresistive random access memory (MRAM). In an identical manner to the nonvolatile memory 21, if the volatile memory 22 is configured with a plurality of modules, it becomes possible to achieve high-speed processing.

The memory controller 23 controls the first memory device 11 during the data transfer. The memory controller 23 is assumed to be configured using a central processing unit (CPU), which is controlled by computer programs, and a suitable logical circuit. However, that is not the only possible case. The memory controller 23 includes an acquiring unit 31, a determining unit 32, a converting unit 33, and a memory unit 34.

The acquiring unit 31 acquires command information used in performing operations related to data transfer. The command information represents information for operating the first memory device 11 from the outside and is assumed to be, for example, generated by the host computer in which the external memory 13 is built-in (i.e., stored in the external memory 13). However, that is not the only possible case.

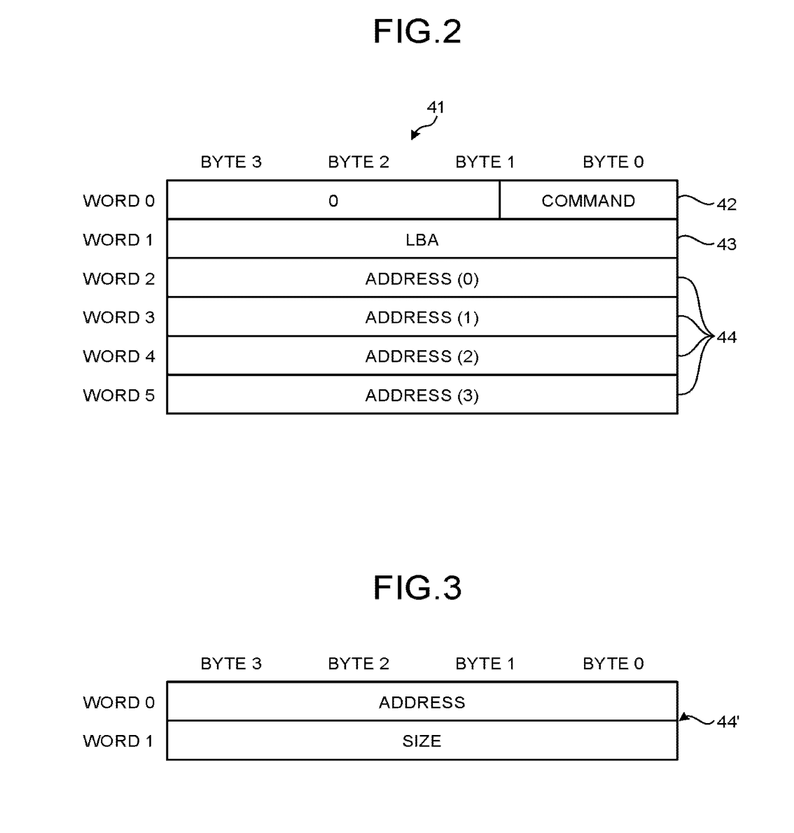

FIG. 2 is a diagram illustrating command information 41. In this example, the command information 41 is made of four bytes×six words and includes a command identifier 42, logical block address information 43, and address information 44. In this example, the command information 41 is assumed to be complying with the SATA standard or the NVMe standard. However, that is not the only possible case.

The command identifier 42 represents information indicating the details of the operations performed during data transfer and, for example, enables identification of reading and writing. When the command identifier 42 indicates reading, an instruction is included in the initial command information 41 for reading data from the first memory device 11 or the second memory device 12 and writing the data in the external memory 13. When the command identifier 42 indicates writing, an instruction is included in the initial command information 41 for reading data from the external memory 13 and writing the data in the first memory device 11 or the second memory device 12.

The logical block address information 43 indicates the access position having data blocks of a predetermined collective size (for example, 512 bytes) as the basic units. The predetermined size and the number of data blocks can be identified from the command information or can be determined from the address information 44 (described below).

The address information 44 includes the memory addresses of the memory areas that are to be accessed during data transfer. When the command identifier 42 indicates reading, the data read from the nonvolatile memory 21 is written in the memory areas specified in the address information 44. When the command identifier 42 indicates writing, data is read from the memory areas specified in the address information 44, and the read data is written in the nonvolatile memory 21. In the first embodiment, the memory addresses included in the address information 44 are assumed to be information indicating specific bytes expressed with 32 bits or 64 bits in the address space (byte addressing). However, that is not the only possible case. Meanwhile, the address information 44 included in a single set of command information 41 can have a list structure of a plurality of memory addresses, as is the case of the physical region page (PRP) list in NVMe.

The data identified by a single set of address information 44 can have a fixed data size such as 4 KB or can have a variable data size different for each set of address information 44. In the case of setting a variable data size, the address information 44 can include information indicating the data size in addition to the memory addresses. FIG. 3 is a diagram illustrating address information 44′ that further includes information indicating the data size. In this example, the address information 44′ is defined using NVMe or SCSI (which stands for Small Computer System Interface), and includes the memory addresses indicating memory areas and information indicating the data size.

The determining unit 32 determines, based on the command information 41 and external address space information 51, whether the memory area indicated by the address information 44 belongs to a specific external address space 55 in the external memory 13. The specific external address space 55 represents a specific address space in the memory area of the external memory 13. The memory area corresponding to the specific external address space 55 (i.e., a specific internal address space 56 (described later)) is assumed to be physically installed in the first memory device 11 (in the first embodiment, in the volatile memory 22), and need not be installed in the external memory 13. The specific external address space 55 is assumed to be a fixed value that is set in advance. However, that is not the only possible case. The external address space information 51 is information indicating the specific external address space 55. In FIG. 1 is illustrated a configuration in which the external address space information 51 is stored in the memory unit 34 that is installed in the memory controller 23. However, that is not the only possible case.

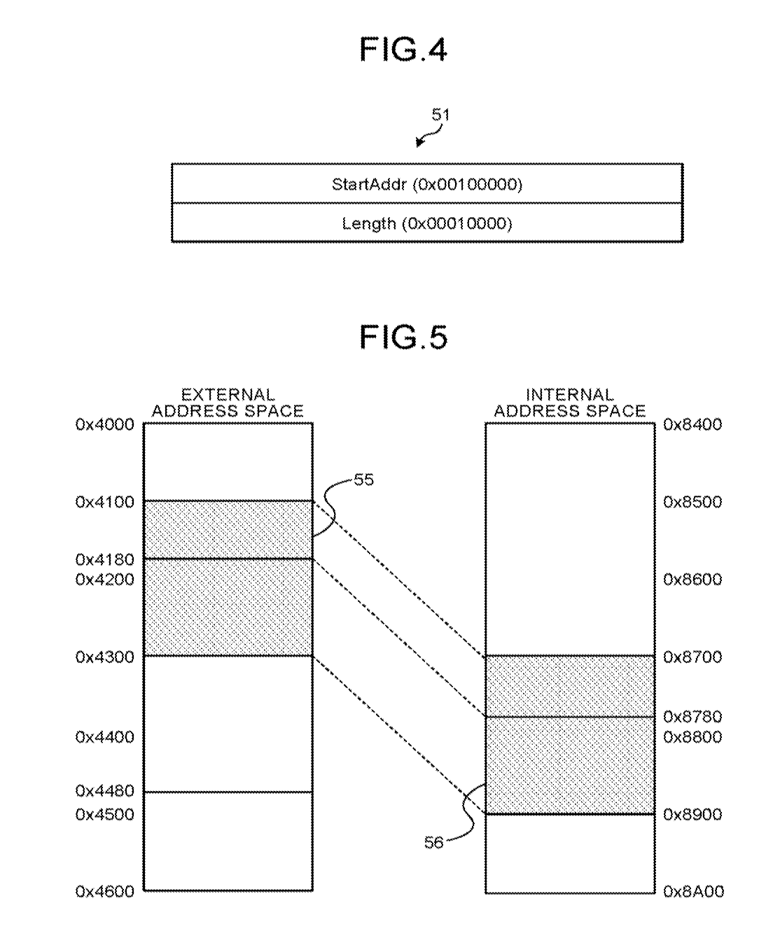

FIG. 4 is a diagram illustrating the external address space information 51. In this example, the external address space information 51 includes address information StartAddr indicating the start of the address space, and includes Length indicating the length of the address space. In this example, the external address space information 51 indicates an area equivalent to 0x00010000 (65536) bytes starting from the memory address 0x00100000. That is, it is indicated that the address space from the memory address 0x00100000 to the memory address 0x0010FFFF represents the specific external address space 55.

In the PCIe interface, if the base address register (BAR) that is one of PCI configuration registers is controlled, the memory area of a PCIe device can be assigned in a specific address space. The external address space information 51 either can be information fixed in the first memory device 11 or can be information that is programmable from outside such as from a BAR.

When a memory area (a first memory area) indicated by the address information 44 (first address information) belongs to the specific external address space 55; the converting unit 33 converts, based on conversion information 52, the address information 44 (the first address information) into the address information 44 (second address information) indicating a memory area (a second memory area) belonging to the specific internal address space 56. Herein, the specific internal address space 56 represents a specific address space in the memory area of the volatile memory 22 of the first memory device 11. Although the specific internal address space 56 is assumed to be a fixed value that is set in advance, that is not the only possible case. The conversion information 52 indicates the correspondence relationship between the specific external address space 55 and the specific internal address space 56. In FIG. 1 is illustrated a configuration in which the conversion information 52 is stored in the memory unit 34 that is installed in the memory controller 23. However, that is not the only possible case.

FIG. 5 is a diagram that schematically illustrates an operation for converting a memory area (a first memory area) belonging to the specific external address space 55 into a memory area (a second memory area) belonging to the specific internal address space 56. In this example, it is illustrated that the specific external address space 55 identified by memory addresses 0x4100 to 0x4300 corresponds to the specific internal address space 56 identified by memory addresses 0x8700 to 0x8900.

For example, in the command information 41 acquired by the acquiring unit 31, if the address information 44 includes the memory address “0x4180”, then the determining unit 32 determines, based on the external address space information 51, that the memory address “0x4180” belongs to the specific external address space 55 from “0x4100” to “0x4300”. Then, based on the conversion information 52, the converting unit 33 converts the address information 44 including the memory address “0x4180” into the address information 44 that includes the corresponding memory address “0x8780” in the specific internal address space 56. Subsequently, the converting unit 33 outputs, to the transferring unit 24 (described later), the command information 41 including the post-conversion address information 44.

Meanwhile, for example, if the address information 44 acquired by the acquiring unit 31 includes the memory address “0x4480”, then the determining unit 32 determines that the memory address “0x4480” does not belong to the specific external address space 55 from “0x4100” to “0x4300”. Then, the converting unit 33 outputs, to the transferring unit 24, the command information 41 including the memory address “0x4480” without modification.

The transferring unit 24 follows the command information 41 output from the converting unit 33, and transfers the target data for data transfer among the nonvolatile memory 21, the volatile memory 22, the second memory device 12, and the external memory 13.

For example, when reading is instructed in the command identifier 42, the transferring unit 24 reads data from the nonvolatile memory 21 and writes that data in the memory area indicated by the address information 44. Herein, if the determining unit 32 determines that the first memory area belongs to the specific external address space 55 and if the converting unit 33 has converted the address information 44 to indicate the second memory area, writing is done in the specific internal address space 56 of the volatile memory 22. On the other hand, if the determining unit 32 determines that the first-type memory area does not belong to the specific external address space 55 and if the address information 44 has not been converted, writing is done in the external memory 13.

When writing is instructed in the command identifier 42, the transferring unit 24 reads data from the memory area indicated by the address information 44 and writes that data in the nonvolatile memory 21. Herein, if the determining unit 32 determines that the first memory area belongs to the specific external address space 55 and if the converting unit 33 has converted the address information 44 to indicate the second memory area, reading is done from the specific internal address space 56 of the volatile memory 22. On the other hand, if the determining unit 32 determines that the first memory area does not belong to the specific external address space 55 and if the address information 44 has not been converted, reading is done from the external memory 13.

The transferring unit 24 follows the command information 41 and identifies the area to be accessed in the nonvolatile memory 21. At that time, in an identical manner to a commonly-used SSD, it is assumed that a correspondence table (a logical-physical conversion table) is used that represents the correspondence between the logical address indicated by the logical block address information 43 of the command information 41 and the physical address enabling identification of the corresponding memory area in the nonvolatile memory 21. However, that is not the only possible case.

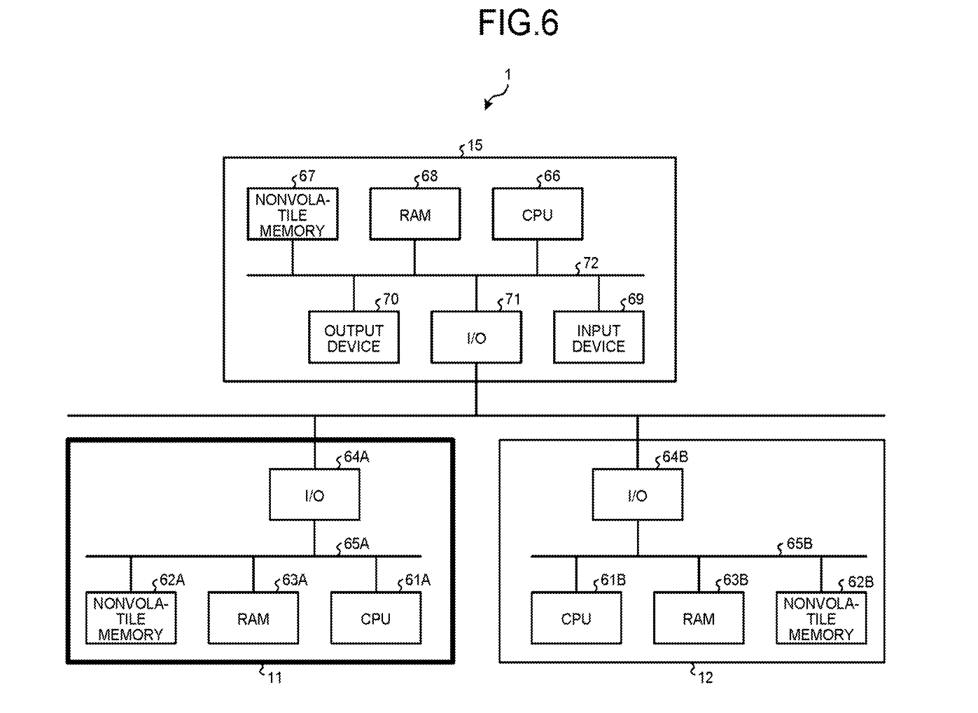

FIG. 6 is a diagram illustrating a hardware configuration of the data transfer system 1. In FIG. 6 are illustrated the first memory device 11, the second memory device 12, and a host computer 15.

The first memory device 11 includes a CPU 61A, a nonvolatile memory 62A such as a NAND flash, a RAM 63A such as a DRAM, and an input-output port (I/O) 64A that are connected to each other by a bus 65A. Similarly, the second memory device 12 includes a CPU 61B, a nonvolatile memory 62B such as a NAND flash, a RAM 63B such as a DRAM, and an input-output port (I/O) 64B that are connected to each other by a bus 65B. The CPU 61A of the first memory device 11 follows a computer program stored in the nonvolatile memory 62A and performs operations to implement the functions of the acquiring unit 31, the determining unit 32, and the converting unit 33. The CPU 61B of the second memory device 12 need not always have the functions to perform operations identical to the CPU 61A of the first memory device 11.

The host computer 15 includes a CPU 66, a nonvolatile memory 67, a RAM 68, an input device 69 such as a mouse or a keyboard, an output device 70 such as a display, and an input-output port (I/O) 71 that are connected to each other via a bus 72. The CPU 66 follows a computer program stored in the nonvolatile memory 67 and performs operations to generate the command information 41. The RAM 68 constitutes at least some part of the external memory 13.

Meanwhile, the hardware configuration illustrated in FIG. 6 is only exemplary, and it is possible to implement various other configurations. For example, the memory devices 11 and 12 that perform data transfer are not limited to be two in number, and there can be three or more memory devices. Moreover, the external memory 13 is not limited to be configured with a single external device (the host computer 15), and can be alternatively configured with a plurality of external devices.

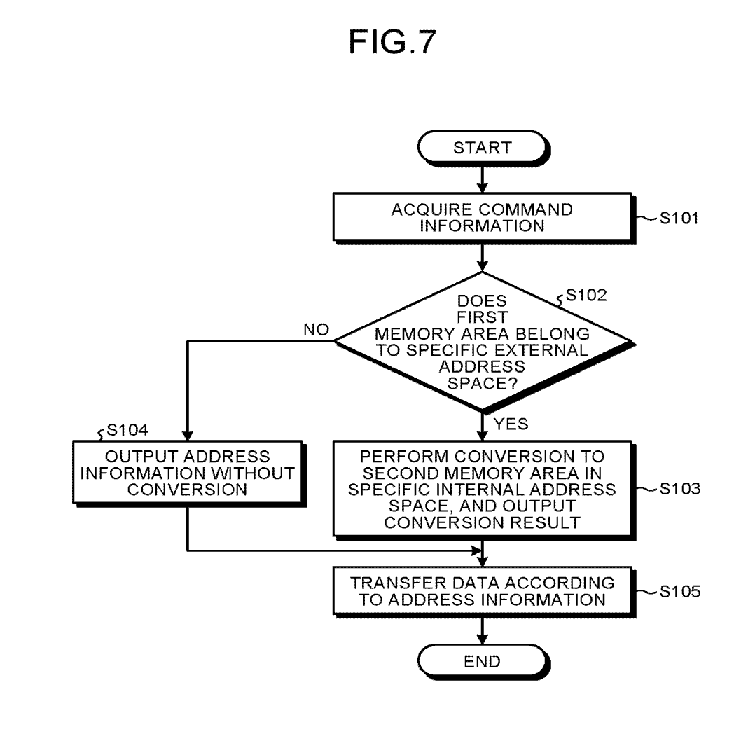

FIG. 7 is a flowchart for explaining a sequence of operations performed in the first memory device 11. When the acquiring unit 31 (see FIG. 1) acquires the command information 41 (see FIG. 2) (S101), the determining unit 32 determines, based on the external address space information 51 (see FIG. 4), whether the first memory area indicated by the address information 44 belongs to the specific external address space 55 (see FIG. 5) (S102).

If the first memory area belongs to the specific external address space 55 (Yes at S102), then the converting unit 33 converts the address information 44 into the address information 44 indicating the second memory area belonging to the specific internal address space 56 (see FIG. 5), and outputs the post-conversion address information 44 (S103). However, if the first memory area does not belong to the specific external address space 55 (No at S102), the converting unit 33 outputs the address information 44 without conversion (S104). The transferring unit 24 transfers data according to the address information 44 specified in the command information 41 that is output from the converting unit 33 (S105).

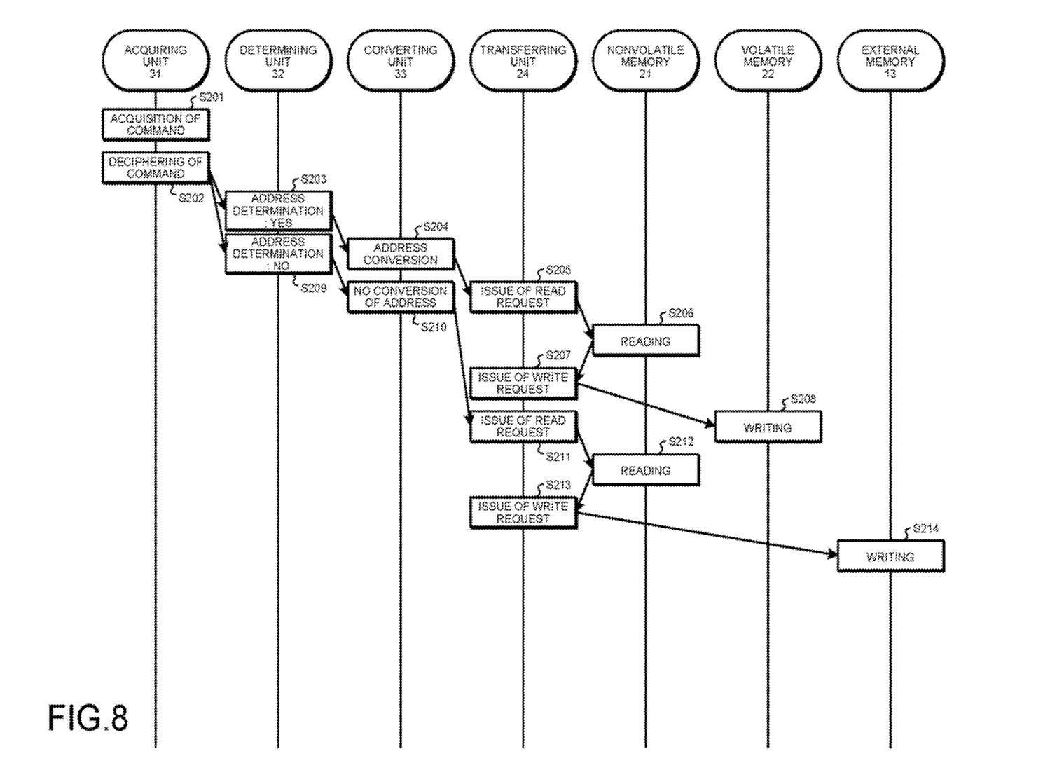

FIG. 8 is a flowchart for explaining a sequence of operations during a reading operation performed in the data transfer system 1. The acquiring unit 31 acquires the command information 41 (S201), and deciphers the contents of the command information 41 (S202). In this example, it is assumed that a reading operation is specified in the command identifier 42, and that two sets of address information 44 are included one of which indicates the first memory area belonging to the specific external address space 55 and the other indicates the second memory area belonging to the address space in the external memory 13 other than the specific external address space 55.

The determining unit 32 performs determination about one of the two sets of the address information 44, and determines that the memory area indicated by the concerned address information 44 belongs to the specific external address space 55 (S203). Based on the determination result, the converting unit 33 converts the concerned address information 44 into the address information 44 indicating the memory area that belongs to the specific internal address space 56, and outputs the post-conversion address information 44 (S204).

The transferring unit 24 follows the command information 41, which includes the post-conversion address information 44, and issues a read request to the nonvolatile memory 21 (S205). Then, the nonvolatile memory 21 reads data according to the read request (S206). Moreover, based on the post-conversion address information 44, the transferring unit 24 issues to the volatile memory 22 a write request for writing the read data (S207). According to the write request, the volatile memory 22 writes data in the memory area in the specific internal address space 56 (S208).

Meanwhile, the determining unit 32 performs determination about the other set of address information 44, and determines that the memory area indicated by the concerned address information 44 does not belong to the specific external address space 55 (S209). Based on the determination result, the converting unit 33 outputs the concerned address information 44 without conversion (S210).

The transferring unit 24 issues a read request to the nonvolatile memory 21 based on the command information 41 (S211). According to the read request, the nonvolatile memory 21 reads data (S212). When reading is completed, the transferring unit 24 issues a data write request to the external memory 13 based on the address information 44 (S213). The external memory 13 writes data according to a write request (S214).

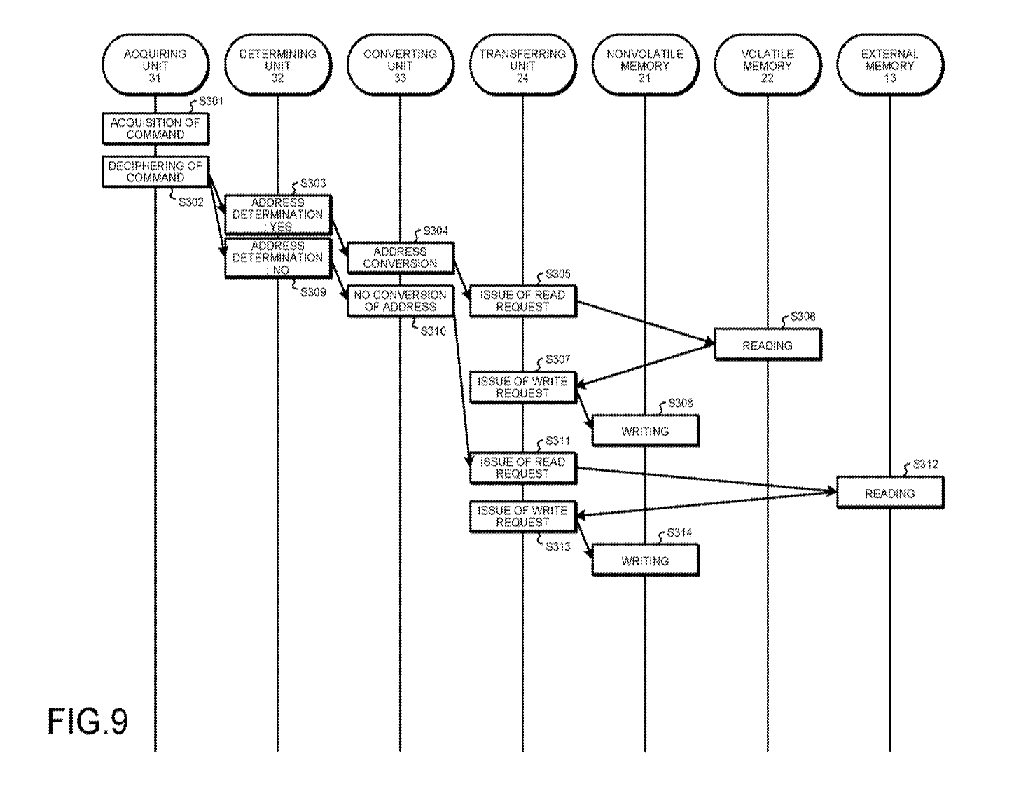

FIG. 9 is a flowchart for explaining a sequence of operations during a writing operation performed in the data transfer system 1. The acquiring unit 31 acquires the command information 41 (S301) and deciphers the contents of the command information (S302). In this example, it is assumed that a writing operation is specified in the command identifier 42, and that two sets of address information 44 are included one of which indicates the first memory area belonging to the specific external address space 55 and the other indicates the second memory area belonging to the address space in the external memory 13 other than the specific external address space 55.

The determining unit 32 performs determination about one of the two sets of the address information 44, and determines that the memory area indicated by the concerned address information 44 belongs to the specific external address space 55 (S303). Based on the determination result, the converting unit 33 converts the concerned address information 44 into the address information 44 indicating the memory area that belongs to the specific internal address space 56, and outputs the post-conversion address information 44 (S304).

The transferring unit 24 follows the command information 41, which includes the post-conversion address information 44, and issues a read request to the volatile memory 22 (S305). Then, the volatile memory 22 reads data according to the read request (S306). When reading is completed, the transferring unit 24 issues a data write request to the nonvolatile memory 21 based on the command information 41 (S307). According to the write request, the nonvolatile memory 21 writes data (S308).

Meanwhile, the determining unit 32 performs determination about the other set of address information 44, and determines that the memory area indicated by the concerned address information 44 does not belong to the specific external address space 55 (S309). Based on the determination result, the converting unit 33 outputs the concerned address information 44 without conversion (S310).

The transferring unit 24 issues a read request to the external memory 13 based on the command information 41 (S311). According to the read request, the external memory 13 reads data (S312). When reading is completed, the transferring unit 24 issues a data write request to the nonvolatile memory 21 based on the command information 41 (S313). According to the write request, the nonvolatile memory 21 writes data (S314).

In the first embodiment, when the address information 44 specified in the command information 41 indicates a memory area belonging to the specific external address space 55, the transfer destination for the target data for data transfer is changed to the memory area in the specific internal address space 56 in the volatile memory 22 of the first memory device 11. As a result, the transfer of data between the first memory device 11 and the second memory device 12 can be done without having to use the external memory 13.

Given below is the explanation of other embodiments with reference to the accompanying drawings. Regarding the constituent elements identical to or producing an identical effect to the first embodiment, the same reference numerals are used and the explanation is not repeated.

### Second Embodiment

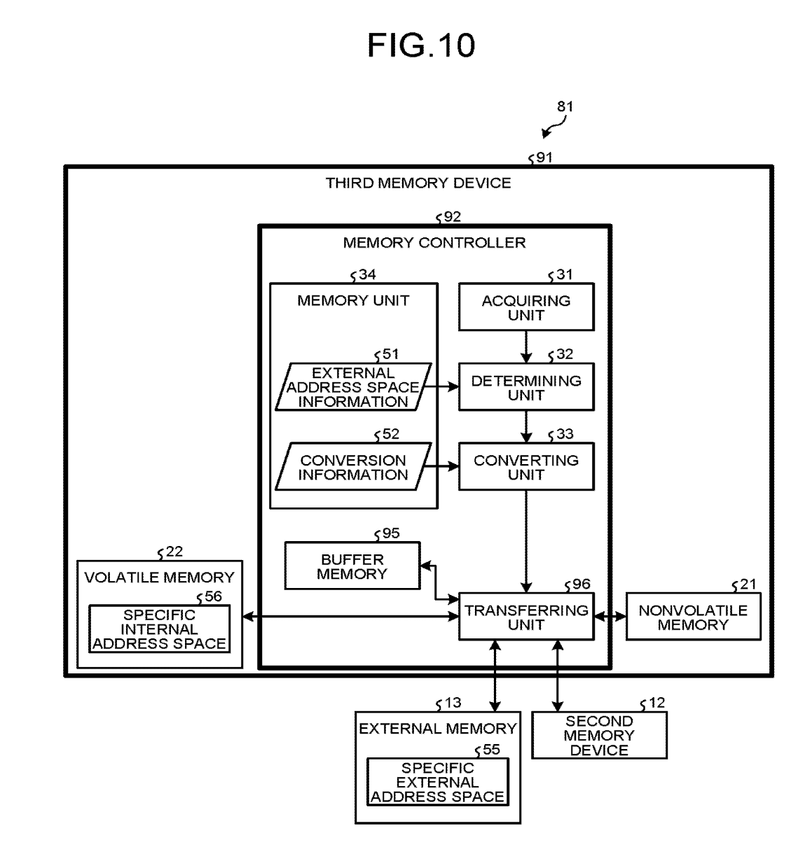

FIG. 10 is a diagram illustrating a configuration of a data transfer system 81 according to a second embodiment. The data transfer system 81 includes a third memory device 91, the second memory device 12, and the external memory 13. Herein, data transfer is done between the third memory device 91 and the second memory device 12.

The third memory device 91 includes the nonvolatile memory 21, the volatile memory 22, and a memory controller 92. Moreover, the memory controller 92 includes the acquiring unit 31, the determining unit 32, the converting unit 33, the memory unit 34, a buffer memory 95, and a transferring unit 96.

The buffer memory 95 is used to temporarily store the target data for data transfer. Herein, the buffer memory 95 is assumed to be a volatile memory represented by a DRAM or an SRAM. However, that is not the only possible case. The buffer memory 95 is used at the time of collectively writing data blocks of a predetermined size in the nonvolatile memory 21. Moreover, the buffer memory 95 is subjected to appropriate flow control by the memory controller 92. In the state in which all memory areas in the buffer memory 95 are used (i.e., in the full state), it is not possible to write new data in the buffer memory 95. As far as the flow control is concerned, for example, it is assumed that the unused memory addresses are managed as a free list in a queue. Then, suitable memory addresses are assigned at the time of performing writing, and the memory addresses are released when writing is completed. However, that is not the only possible method.

Meanwhile, the buffer memory 95 sometimes assumes the role of absorbing the difference between the access speed of the nonvolatile memory 21 and the access speed of the volatile memory 22 or the external memory 13. Moreover, the buffer memory 95 can be used as the work area for performing encoding/decoding of an error correction code (ECC), data encryption/decryption, and a compression operation across a plurality of data blocks. In the second embodiment, although the buffer memory 95 is installed in the memory controller 92, that is not the only possible case. Alternatively, some part of the volatile memory 22 can be used as a buffer memory.

In the second embodiment, the transferring unit 96 performs data transfer via the buffer memory 95. When the determining unit 32 determines that the memory area indicated by the address information 44 belongs to the specific external address space 55, the reading position or the writing position of the target data for data transfer is within the specific internal address space 56 of the volatile memory 22. At that time, if the buffer memory 95 is used during data transfer, it implies that the data transfer is performed between internal memories. That leads to a decline in the processing efficiency. In that regard, when the determining unit 32 determines that the memory area indicated by the address information 44 belongs to the specific external address space 55, the transferring unit 96 directly accesses the volatile memory 22 without using the buffer memory 95. Meanwhile, in the second embodiment, although the transferring unit 96 is installed in the memory controller 92, that is not the only possible case.

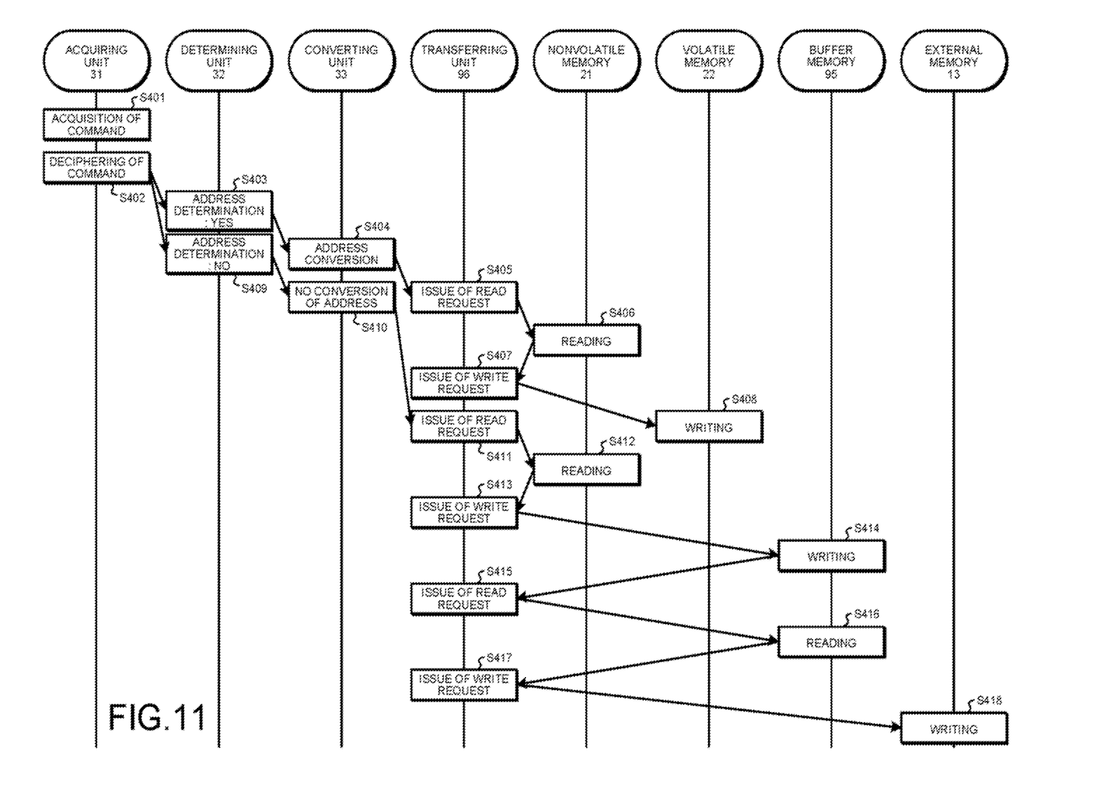

FIG. 11 is a flowchart for explaining a sequence of operations during a reading operation performed in the data transfer system 81. The acquiring unit 31 acquires the command information 41 (S401) and deciphers the contents of the command information 41 (S402). In this example, it is assumed that a reading operation is specified in the command identifier 42, and that two sets of address information 44 are included one of which indicates the first memory area belonging to the specific external address space 55 and the other indicates the second memory area belonging to the address space in the external memory 13 other than the specific external address space 55.

The determining unit 32 performs determination about one of the two sets of the address information 44, and determines that the memory area indicated by the concerned address information 44 belongs to the specific external address space 55 (S403). Based on the determination result, the converting unit 33 converts the concerned address information 44 into the address information 44 indicating the memory area that belongs to the specific internal address space 56, and outputs the post-conversion address information 44 (S404).

The transferring unit 96 issues a read request to the nonvolatile memory 21 based on the command information 41 (S405). Then, the nonvolatile memory 21 reads data according to the read request (S406). Moreover, based on the post-conversion address information 44, the transferring unit 96 issues to the volatile memory 22 a write request for writing the read data (S407). At that time, the transferring unit 96 does not issue a write request or a read request to the buffer memory 95. According to the write request, the volatile memory 22 writes data in the memory area in the specific internal address space 56 (S408).

Meanwhile, the determining unit 32 performs determination about the other set of address information 44, and determines that the memory area indicated by the concerned address information 44 does not belong to the specific external address space 55 (S409). Based on the determination result, the converting unit 33 outputs the concerned address information 44 without conversion (S410).

The transferring unit 96 issues a read request to the nonvolatile memory 21 based on the command information 41 (S411). According to the read request, the nonvolatile memory 21 reads data (S412). When reading is completed, the transferring unit 96 issues a write request for writing the read data in the memory area of the buffer memory 95 assigned according to the flow control (S413). Then, the buffer memory 95 writes the data based on the write request (S414). When writing in the buffer memory 95 is completed, the transferring unit 96 issues a read request to the buffer memory 95 (S415). According to the read request, the buffer memory 95 reads data (S416). When reading is completed, the transferring unit 96 issues a data write request to the external memory 13 based on the command information 41 (3417). The external memory 13 writes data according to the write request (S418).

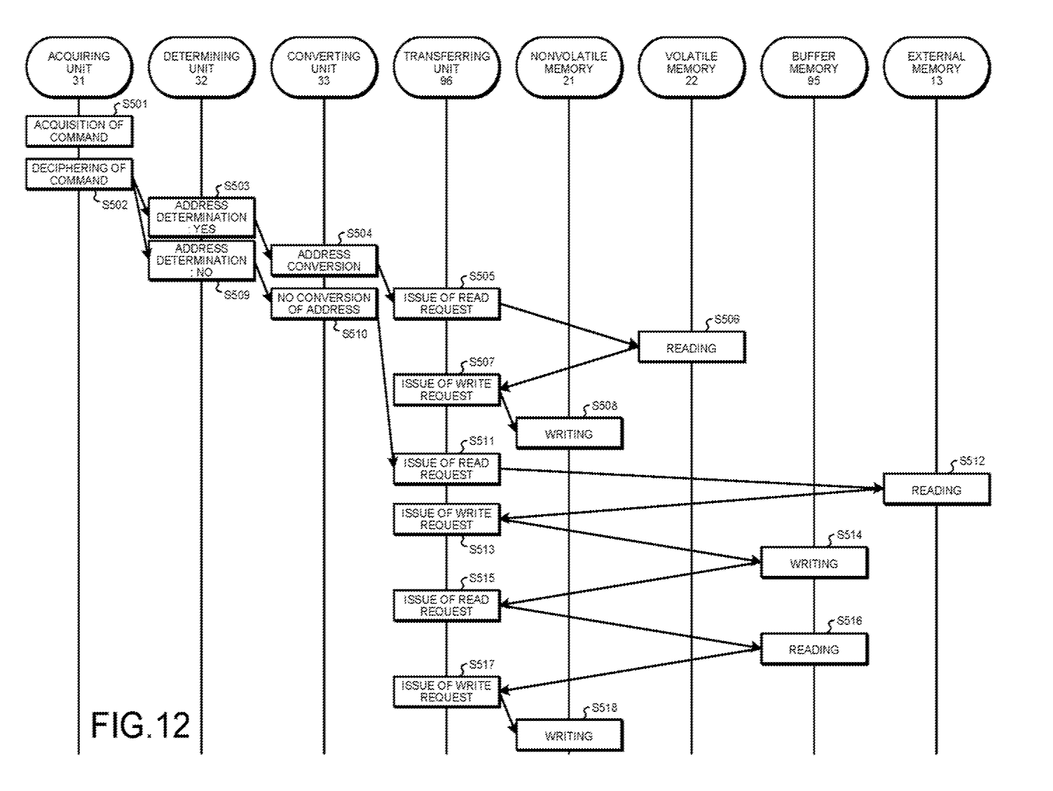

FIG. 12 is a flowchart for explaining a sequence of operations during a writing operation performed in the data transfer system 81. The acquiring unit 31 acquires the command information 41 (S501) and deciphers the contents of the command information (S502). In this example, it is assumed that a writing operation is specified in the command identifier 42, and that two sets of address information 44 are included one of which indicates the first-type memory area belonging to the specific external address space 55 and the other indicates the second-type memory area belonging to the address space in the external memory 13 other than the specific external address space 55.

The determining unit 32 performs determination about one of the two sets of the address information 44, and determines that the memory area indicated by the concerned address information 44 belongs to the specific external address space 55 (S503). Based on the determination result, the converting unit 33 converts the concerned address information 44 into the address information 44 indicating the memory area that belongs to the specific internal address space 56, and outputs the post-conversion address information 44 (S504).

The transferring unit 24 follows the command information 41, which includes the post-conversion address information 44, and issues a read request to the volatile memory 22 (S505). Then, the volatile memory 22 reads data according to the read request (S506). When reading is completed, the transferring unit 96 issues a data write request to the nonvolatile memory 21 based on the command information 41 (S507). At that time, the transferring unit 96 does not issue a write request or a read request to the buffer memory 95. According to the write request, the nonvolatile memory 21 writes data (S508).

Meanwhile, the determining unit 32 performs determination about the other set of address information 44, and determines that the memory area indicated by the concerned address information 44 does not belong to the specific external address space 55 (S509). Based on the determination result, the converting unit 33 outputs the concerned address information 44 without conversion (S510).

The transferring unit 96 issues a read request to the external memory 13 based on the command information 41 (S511). According to the read request, the external memory 13 reads data (S512). When reading is completed, the transferring unit 96 issues a write request for writing the read data in the memory area of the buffer memory 95 assigned according to the flow control (S513). Then, the buffer memory 95 writes the data based on the write request (S514). When writing in the buffer memory 95 is completed, the transferring unit 96 issues a read request to the buffer memory 95 (S515). According to the read request, the buffer memory 95 reads data (S516). When reading is completed, the transferring unit 96 issues a data write request to the nonvolatile memory 21 based on the command information 41 (S517). According to the write request, the nonvolatile memory 21 writes data (S518).

According to the second embodiment, when the memory area indicated by the address information is converted from the external memory 13 to the volatile memory 22 that is the internal memory, not only it becomes possible to skip accessing the external memory 13 but it also becomes possible to skip accessing the buffer memory 95.

### Third Embodiment

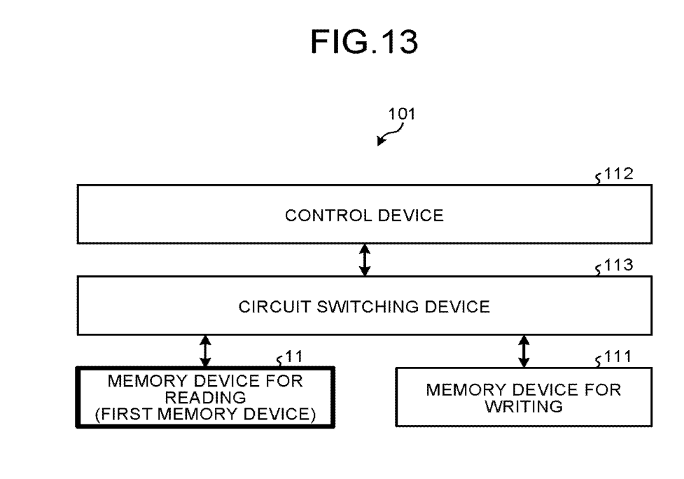

FIG. 13 is a diagram illustrating a configuration of a data transfer system 101 according to a third embodiment. The data transfer system 101 includes the first memory device 11, a memory device 111 for writing, a control device 112, and a circuit switching device 113. In the third embodiment, the first memory device 11, which includes the memory controller 23, is used as a memory device for reading.

As described above, the first memory device 11 includes the volatile memory 22 that is accessible using memory addresses from an external device; and has the address conversion function by which the memory controller 23 converts the memory address (the address information 44) indicating a memory area in the external memory 13 into the memory address indicating a memory address in the specific internal address space 56 of the volatile memory 22. When such address conversion is performed, the first memory device 11 stores the read data in the volatile memory 22.

The memory device 111 for writing has the function of storing the data that is read from the first memory device 11, but need not have the address conversion function using the memory controller 23. In response to a write command, the memory device 111 for writing writes the data, which is read from the external memory 13 or the volatile memory 22 of the first memory device 11, in a nonvolatile memory installed therein.

The control device 112 assumes the role of controlling the entire system, and generates and issues the command information 41 as the host of the first memory device 11 and the memory device 111 for writing. The control device 112 is assumed to be a computer such as a personal computer (PC) or a server. However, that is not the only possible case.

The circuit switching device 113 connects the first memory device 11, the memory device 111 for writing, and the control device 112 to each other, and enables data transmission and data reception among those devices. Herein, the circuit switching device 113 is assumed to be a device that, like a crossbar switch, singularly establishes mutual connection among a plurality of devices. However, that is not the only possible case. Alternatively, for example, it is possible to replace the circuit switching device 113 with a configuration in which exchange of packets is performed using a network having a combination of routers. Meanwhile, if the circuit switching device 113 has a hierarchical structure, it becomes possible to build a mutual connection network, such as a mesh network or a tree network, having various configurations (topologies).

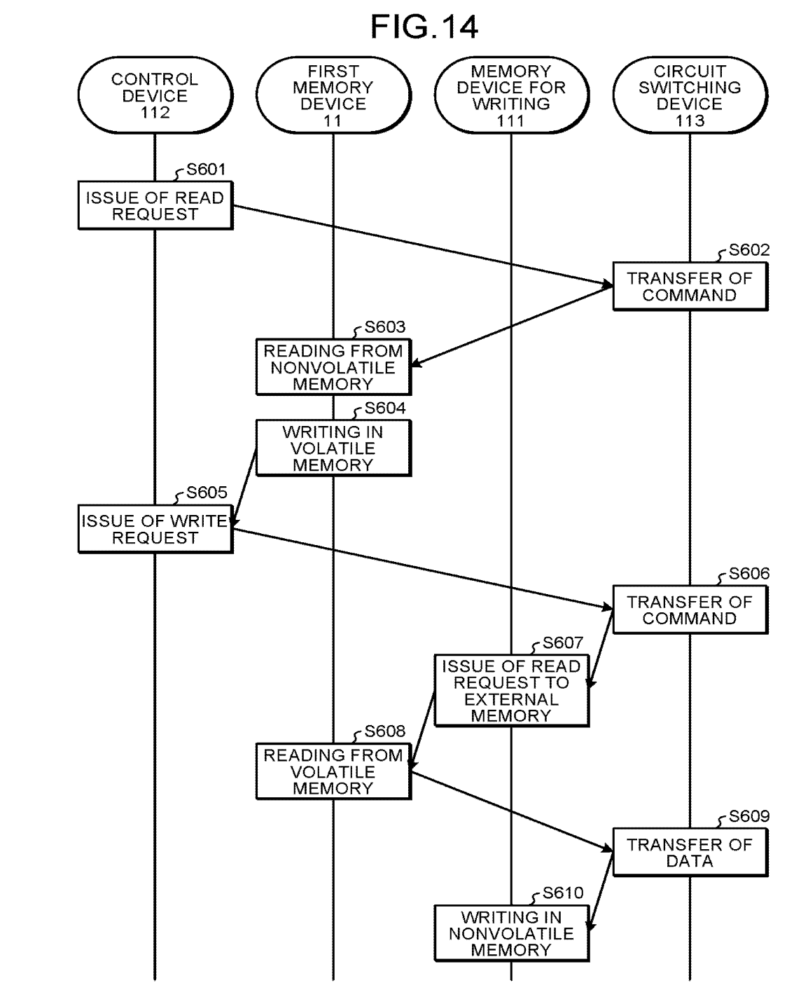

FIG. 14 is a flowchart for explaining a sequence of operations during a reading and writing operation performed in the data transfer system 101. The control device 112 generates the command information 41 for the purpose of reading the data stored in the first memory device 11, and issues a read request to the first memory device 11 (S601). At that time, one or more sets of the address information 44 specified in the command information 41 indicate the memory areas in the volatile memory 22 of the first memory device 11. The command information 41 is input to the circuit switching device 113 and then transferred to the first memory device 11 (S602). The first memory device 11 reads data from the nonvolatile memory 21 according to the acquired command information 41 (S603), and writes the read data in the volatile memory 22 according to the address information 44 specified in the command information 41 (S604).

When the reading operation is completed, the control device 112 generates the command information 41 for the purpose of writing data in the memory device 111 for writing, and issues a write request to the memory device 111 for writing (S605). At that time, one or more sets of the address information 44 specified in the command information 41 include one or more sets of the address information 44 specified in the command information 41 during the reading operation described above. The command information 41 for the writing operation is input to the circuit switching device 113 and then transferred to the memory device 111 for writing (S606). The memory device 111 for writing follows the address information 44 specified in the acquired command information 41, and issues a read request to the volatile memory 22 of the first memory device 11 or to the external memory 13 (S607). At that time, regardless of whether data is stored in the volatile memory 22, the memory device 111 for writing issues a request to the external memory 13. Upon acquiring the read request, the first memory device 11 reads data from the volatile memory 22 (from the specific internal address space 56 corresponding to the specific external address space 55 in the external memory 13 to which the read request is issued) (S608). The read data is input to the circuit switching device 113 and then transferred to the memory device 111 for writing (S609). Then, the memory device 111 for writing writes the acquired data in the nonvolatile memory according to the command information 41 (S610).

As described in the third embodiment, if the first memory device 11 including the memory controller 23 is used as a memory device for reading, then accessing an external memory can be skipped even if the first memory device 11 is not used as the memory device 111 for writing. Besides, since no special commands are needed, the implementation can be done without affecting the specifications of a commonly-used interface (such as NVMe).

### Fourth Embodiment

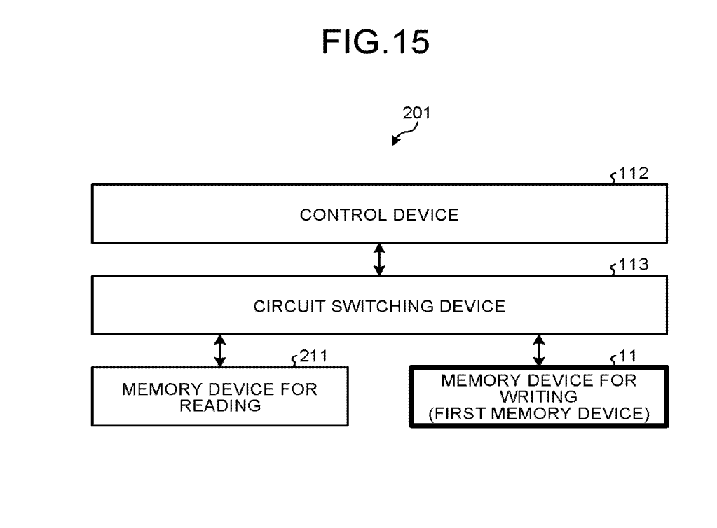

FIG. 15 is a diagram illustrating a configuration of a data transfer system 201 according to a fourth embodiment. The data transfer system 201 includes the first memory device 11, a memory device 211 for reading, the control device 112, and the circuit switching device 113. In the fourth embodiment, the first memory device 11 including the memory controller 23 is used as a memory device for writing.

The memory device 211 for reading has the function of storing and reading the data written in the first memory device 11, but need not have the address conversion function using the memory controller 23. In response to a read command, the memory device 211 for reading reads the data from a nonvolatile memory installed therein.

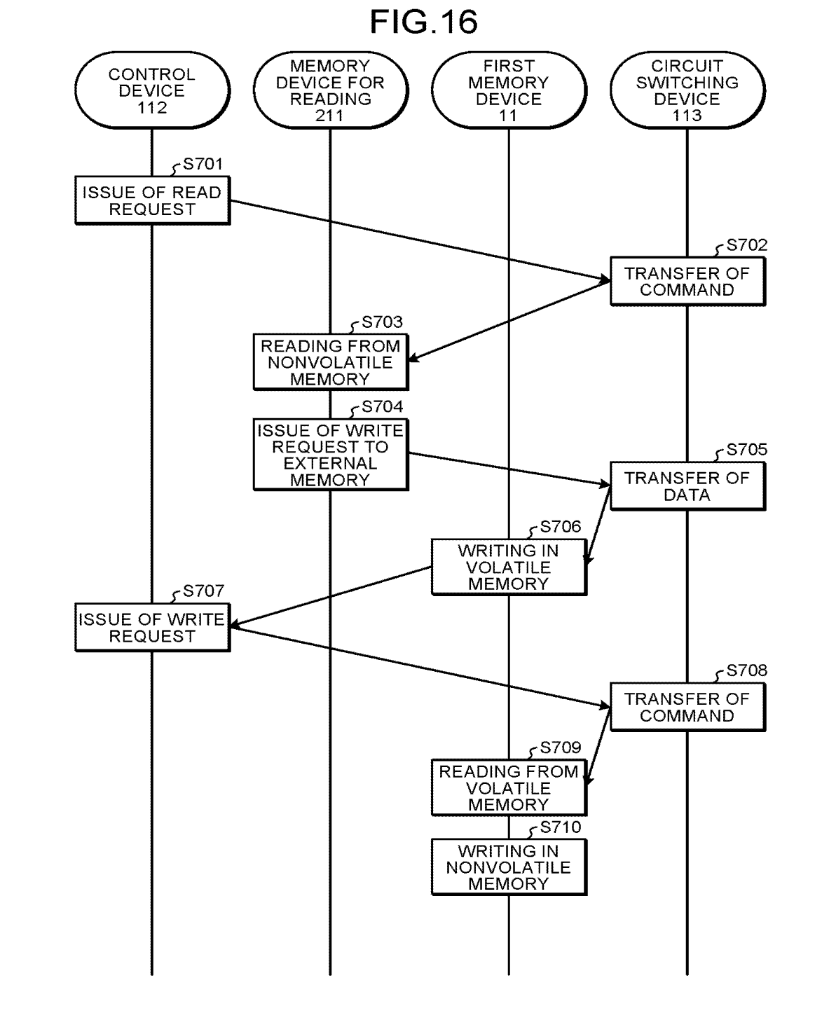

FIG. 16 is a flowchart for explaining a sequence of operations during a reading and writing operation performed in the data transfer system 201. The control device 112 generates the command information 41 for the purpose of reading the data stored in the memory device 211 for reading, and issues a read request to the memory device 211 for reading (S701). At that time, one or more sets of the address information 44 specified in the command information 41 indicate the memory areas in the volatile memory 22 of the first memory device 11. The command information 41 is input to the circuit switching device 113 and then transferred to the memory device 211 for reading (S702). The memory device 211 for reading reads data from the nonvolatile memory thereof according to the acquired command information 41 (S703), and writes the read data in the external memory 13 according to the address information 44 specified in the command information 41 (S704). At that time, regardless of whether the volatile memory 22 of the first memory device 11 is the destination for data writing, the memory device 211 for reading issues a write request to the external memory 13. The read data is input to the circuit switching device 113 and then transferred to the first memory device (S705). Upon receiving the read data and the write request, the first memory device 11 writes the data in the volatile memory 22 (S706).

When the reading operation is completed, the control device 112 generates the command information 41 for the purpose of writing data in the first memory device 11 and issues a write request to the first memory device 11 (S707). At that time, one or more sets of the address information 44 specified in the command information 41 include one or more sets of the address information 44 specified in the command information 41 during the reading operation described above. The command information 41 for the writing operation is input to the circuit switching device 113 and then transferred to the first memory device 11 (S708). The first memory device 11 follows the address information 44 specified in the acquired command information 41 (i.e., follows the address information 44 converted to indicate a memory area in the specific internal address space 56) and reads data from the volatile memory 22 (S709), and writes the read data in the nonvolatile memory (S710).

As described in the fourth embodiment, if the first memory device 11 including the memory controller 23 is used as a memory device for writing, then accessing an external memory can be skipped even if the first memory device 11 is not used as the memory device 211 for reading. Besides, since no special commands are needed, the implementation can be done without affecting the specifications of a commonly-used interface (such as NVMe).

Meanwhile, the computer program for implementing the functions described above can be recorded as an installable or an executable file in a computer-readable recording medium such as a compact disk read only memory (CD-ROM), a flexible disk (FD), a compact disk recordable (CD-R), or a digital versatile disk (DVD). Alternatively, the computer program can be downloaded from a predetermined memory device on a network in a predetermined information processing device. Still alternatively, the computer program can be stored in advance in a read only memory (ROM) and provided in a predetermined information processing device. Meanwhile, the computer program can be configured with a plurality of modules for implementing the functions of the constituent elements described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller that controls data transfer performed between a memory device and another memory device, the memory controller comprising:
an acquiring unit that acquires command information which contains first address information indicating a first memory area to be accessed during the data transfer;
a determining unit that determines whether the first memory area belongs to a specific external address space which represents a specific address space in an external memory; and
a converting unit that, when the first memory area belongs to the specific external address space, converts, based on conversion information indicating correspondence relationship between the specific external address space and a specific internal address space which represents a specific address space in the first memory device, the first address information into second address information indicating a second memory area belonging to the specific internal address space.

2. The memory controller according to claim 1, wherein the memory device as well as the other memory device is a solid state drive (SSD).

3. The memory controller according to claim 2, wherein the command information contains information for performing operations complying with SATA standard.

4. The memory controller according to claim 2, wherein the command information contains information for performing operations complying with SCSI standard.

5. The memory controller according to claim 2, wherein the command information contains information for performing operations complying with NVMe standard.

6. The memory controller according to claim 1, wherein the specific internal address space is set in a work area of the memory device.

7. The memory controller according to claim 1, further comprising:
a buffer memory that is used to temporarily store data to be subjected to the data transfer; and
a transferring unit that transfers the data among the memory device, the other memory device, and the external memory according to the command information, wherein
when the first memory area belongs to the specific external address space, the transferring unit transfers the data to the second memory area without transferring the data to the buffer memory.

8. A memory device comprising a memory controller that controls data transfer performed between a memory device and another memory device, wherein
the memory controller includes
an acquiring unit that acquires command information which contains first address information indicating a first memory area to be accessed during the data transfer,
a determining unit that determines whether the first memory area belongs to a specific external address space which represents a specific address space in an external memory, and
a converting unit that, when the first memory area belongs to the specific external address space, converts, based on conversion information indicating correspondence relationship between the specific external address space and a specific internal address space which represents a specific address space in the first memory device, the first address information into second address information indicating a second memory area belonging to the specific internal address space.

9. A data transfer system comprising:
a memory device;
another memory device; and
a control device, wherein
the memory device includes a memory controller that controls data transfer performed with the other memory device,
the control device includes an external memory and generates command information which contains first address information indicating a first memory area to be accessed during the data transfer, and
the memory controller includes
an acquiring unit that acquires the command information,
a determining unit that determines whether the first memory area belongs to a specific external address space which represents a specific address space in the external memory, and
a converting unit that, when the first memory area belongs to the specific external address space, converts, based on conversion information indicating correspondence relationship between the specific external address space and a specific internal address space which represents a specific address space in the first memory device, the first address information into second address information indicating a second memory area belonging to the specific internal address space.

10. The data transfer system according to claim 9, wherein
the memory device is used as a memory device for reading, and
the other memory device is used as a memory device for writing.

11. The data transfer system according to claim 9, wherein
the memory device is used as a memory device for writing, and
the other memory device is used as a memory device for reading.

12. A data transfer method for controlling data transfer performed between a memory device and another memory device, the data transfer method comprising:
acquiring command information which contains first address information indicating a first memory area to be accessed during the data transfer;
determining whether the first memory area belongs to a specific external address space which represents a specific address space in an external memory; and
converting that, when the first memory area belongs to the specific external address space, includes converting, based on conversion information indicating correspondence relationship between the specific external address space and a specific internal address space which represents a specific address space in the first memory device, the first address information into second address information indicating a second memory area belonging to the specific internal address space.

13. A computer program product having a non-transitory computer readable medium including a data transfer program, wherein the data transfer program, when executed by a computer that controls a memory device which performs data transfer with another memory device, causes the computer to perform:
acquiring command information which contains first address information indicating a first memory area to be accessed during the data transfer;
determining whether the first memory area belongs to a specific external address space which represents a specific address space in an external memory; and
converting that, when the first memory area belongs to the specific external address space, includes converting, based on conversion information indicating correspondence relationship between the specific external address space and a specific internal address space which represents a specific address space in the first memory device, the first address information into second address information indicating a second memory area belonging to the specific internal address space.
